(19) United States
(12) Patent Application Publication
(10) Pub. No.: US 2006/0007239 A1
(43) Pub. Date: Jan. 12, 2006

(54) Color correction system

(76) Inventor: Charles Frederick Harrison, Seattle, WA (US)

Correspondence Address: TAROLLI, SUNDHEIM, COVELL & TUMMINO L.L.P., 526 SUPERIOR AVENUE, SUITE 1111, CLEVEVLAND, OH, 44114, US

(21) Appl. No.: 10/885,421

(22) Filed: Jul. 6, 2004

(51) Int. Cl. G09G 5/02

(52) U.S. Cl. 345/590

(57) ABSTRACT

Systems and methods are provided for color correction for a display system. A calibration module determines values for at least one spatially dependent precorrection coefficient for each of a plurality of representative pixel locations on an associated display. A precorrection module precorrects a plurality of input chromaticity values associated with a pixel location according to the pixel location and the determined values of the at least one spatially dependent precorrection coefficient to produce precorrected chromaticity values.

### TECHNICAL FIELD

The present invention relates to image correction systems and methods and, more particularly, to a color correction system for an associated display.

### BACKGROUND OF THE INVENTION

The human eye is very sensitive to differences in color and shading. Even minor differences in the chromatic properties of display systems can be noted by a human observer when the displayed images are presented concurrently. Unfortunately, no display system is ideal, and the chromatic properties of display systems will vary across systems, making it difficult to display multiple images in a coherent fashion. The chromatic properties of a display system can also vary at different pixel locations associated with a display system. These differences are especially noticeable when multiple displays are utilized to display a large image, allowing a human observer to notice chromatic discrepancies within a display that would not be easily noticed when the display is observed separately.

For example, video projectors can be arranged in arrays of two or more projectors in order to project a tiled composite image in which each projector in the array projects a corresponding component image of the composite image. When projecting large images, video projector arrays can provide enhanced brightness and resolution of the composite image and can reduce the requisite distance between the projectors and the surface onto which the composite image is projected. When projecting a composite image via a projector array, it can be desirable to match or blend the adjacent edges of the component images in order to provide a seamless composite image. The extent to which adjacent edges of the images can be smoothly blended is limited by the degree of chromatic inconsistency amongst the projectors comprising the array.

### SUMMARY OF THE INVENTION

In accordance with one aspect of the invention, a color display correction system is provided. The color display correction system includes a calibration module that determines values for at least one spatially dependent precorrection coefficient for each of a plurality of representative pixel locations on an associated display. A precorrection module precorrects a plurality of input chromaticity values associated with a pixel location according to the pixel location and the determined values of the at least one spatially dependent precorrection coefficient to produce precorrected chromaticity values.

In accordance with another aspect of the invention, a method is provided for calibrating a display system. A calibration input is provided to a display to instruct the display system to display a desired color at a plurality of pixel locations. An actual color displayed at the plurality of pixel locations is measured. A set of calibration coefficients associated with each of the plurality of pixel locations is computed according to the desired color and the actual color at each pixel location.

### BRIEF DESCRIPTION OF THE DRAWINGS

FIG. 1 illustrates a block diagram of a display system incorporating a color correction system in accordance with an aspect of the present invention.

FIG. 2 illustrates a block diagram of an exemplary calibration module for a color correction system in accordance with an aspect of the present invention.

FIG. 3 illustrates a block diagram of an exemplary chromaticity precorrection module for a color correction system in accordance with an aspect of the present invention.

FIG. 4 illustrates an exemplary implementation of the present invention in a multi-tiled projection system.

FIG. 5 illustrates an exemplary methodology for calibrating a display system in accordance with an aspect of the present invention.

FIG. 6 illustrates an exemplary methodology for precorrecting a run-time input to a display system in accordance with an aspect of the present invention.

### DETAILED DESCRIPTION OF INVENTION

The present invention relates to systems and methods for providing color correction to a display system. In accordance with the present invention, calibration is performed across a number of pixel locations on the display to provide representative precorrection coefficients distributed across the display. Accordingly, the behavior of the display system can be modeled in a spatially-dependent fashion, and the correction provided to the display input can be tailored to specific regions of the image. In one implementation, a set of coefficients is interpolated for each pixel in the display from the representative precorrection coefficients to provide pixel-specific corrections to a displayed image. A color correction system in accordance with an aspect of the present invention finds special utility for maintaining uniform chromaticity characteristics across and within a plurality of display systems comprising a multi-tiled display. It will be appreciated that the word “chromaticity” is used broadly herein to encompass the full colorimetric characteristics of a displayed color, distinguishing colors appearing different in hue, saturation, and/or brightness.

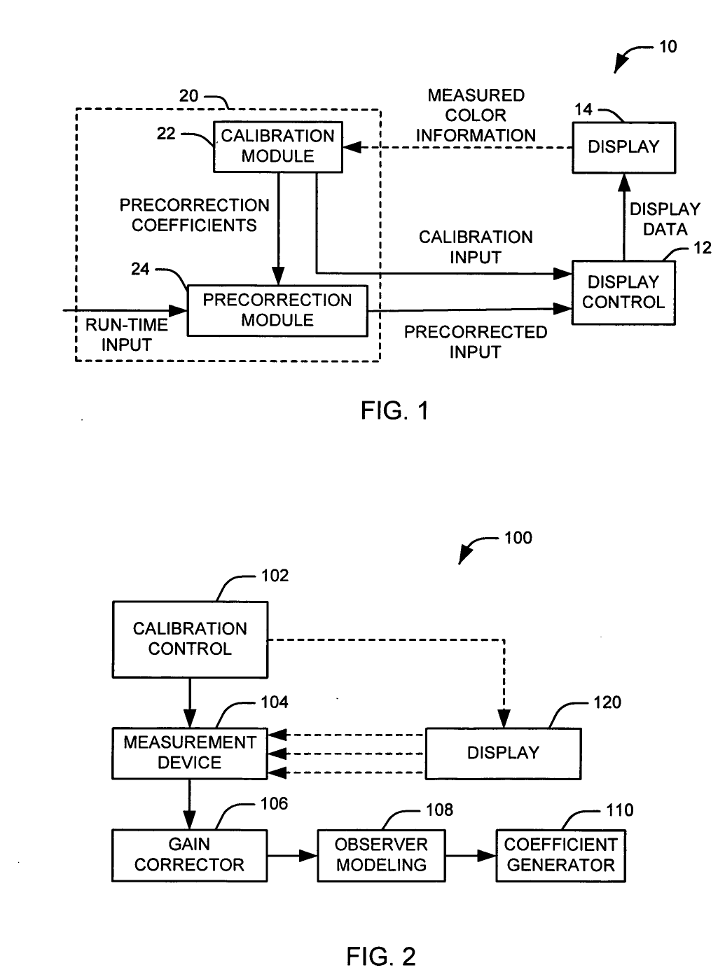

FIG. 1 illustrates a display system 10 incorporating a color correction system 20 in accordance with an aspect of the present invention. The illustrated display system receives an input signal at a display control 12 comprising a set of chromaticity values. Each set of chromaticity values defines a desired color to be displayed as a pixel having an associated location on a display 14. For example, a set of chromaticity values can represent three chromatic primaries, such as red, green, and blue primaries in a RGB color space, luminance, blue chromaticity, and red chromaticity primaries in a YCbCr color space, or cyan, magenta, and yellow primaries in a CMY color space. It will be appreciated that one or more portions of the color correction apparatus 20 can be implemented as computer software running on a microprocessor.

Within the color correction apparatus 20, a calibration module 22 generates a calibration input that directs the display control 12 to display a desired color pattern over one or more pixel locations on the display 14. The calibration input can bypass a precorrection module 24 associated with the color correction apparatus 20. The display control 12 provides color information based on the calibration input to the display via an appropriate mechanism. For example, if the display is a computer monitor screen, the data can be provided electrically as a series of intensity values to various light-producing elements in the monitor representing primaries in a desired color space. Alternatively, if the display 14 is a projection screen, the display control 12 can provide the image data as a visible light projection onto the screen. It will be appreciated that the display 14 and the display control 12 can take other forms in accordance with the present invention.

Color measurements are taken at a plurality of pixel locations on the display 14 by a measuring device (not shown) associated with the calibration module 22. For example, the measurement device can include a spectroradiometer that measures the color displayed at a given pixel location. The color measurements provide information as to the actual color displayed at the location on the display. These measurements can be repeated for each of a plurality of calibration inputs, each representing a different color pattern to be displayed. In an exemplary implementation, each color pattern is a solid color displayed across the display, including a standard zero-input (black), as well as a full brightness input and half-brightness input for each of a plurality of chromaticity primaries associated with the display. The calibration module 22 can compare the data from the color measurements for a given location to the corresponding calibration input to determine a chromaticity model, defined by a set of at least one precorrection coefficient for each of the plurality of locations.

The calculated precorrection coefficients for each location are then provided to a precorrection module 24. The precorrection module 24 provides one or more spatially dependent precorrections to a run-time input associated with a given pixel location. The precorrections can include corrections to a contrast associated with the pixel, variations in the chromatic primaries associated with pixel, or variations in the black and white levels of the pixel. Each precorrection applied to the input is a function of the associated pixel location of the input and one or more sets of precorrection coefficients from the calibration module 22. For example, a set of precorrection coefficients having an associated pixel location closest to the input pixel location can be applied to the input. Alternatively, an appropriate set of precorrection coefficients can be calculated via interpolation according to one or more of the calculated coefficient sets associated with the input pixel location. Once the precorrections have been applied to the input, the input is provided to the display control 12 to provide corrected display data to the display 14.

FIG. 2 illustrates an exemplary calibration module 100 for a color correction system in accordance with an aspect of the present invention. The calibration module 100 models various chromaticity properties of an associated display 120 by measuring the response of the display to a series of calibration inputs. It will be appreciated that the chromaticity precorrection module can be implemented as a computer software program on a computer readable medium, as hardware circuitry, or as a combination of the two. Accordingly, the illustrated functional components of the module can represent one or more software programs or portions thereof operating in a data processing system (e.g., a microprocessor) or appropriate dedicated circuitry for the described function. In the illustrated implementation, the three chromaticity values are discussed generally as red, blue and green components of a given input pixel (e.g., consistent with an RGB color space), but it will be appreciated that the input can be represented by a number of other chromaticity models, such as a YCbCr (luminance, blue chromaticity, and red chromaticity) model or a CMY (Cyan, Magenta, and Yellow) model.

The calibration inputs can be selected by a calibration control 102 to produce a range of desired color patterns of the display. In an exemplary embodiment, the color patterns are solid colors, and readings can be taken for a zero-input pattern (e.g., a black display), a pattern for each of a plurality of color primaries (e.g., red, blue, and green) at mid-brightness, and a pattern for each of the color primaries at full brightness. Readings can be taken by a measurement device 104 at a plurality of representative pixel locations, with sets of one of more pixel locations representing respective portions of the display. For example, the representative pixel locations can be arranged in a rectangular grid, with a given rectangular area defined by the grid being represented by its corner points. It will be recognized that the measurement taken at a representative pixel location may respond to light over an area larger than a single pixel. Coefficient values for other pixels associated with a given region of the display can be derived from respective coefficient values of the one or more representative pixels for that region. In the illustrated implementation, a measurement device 104 is driven by the calibration control 102 to take a plurality of measurements corresponding to desired pixel locations on the display during each calibration input. For example, the calibration control 102 can comprise an automated system that aligns the measurement device with each of a plurality of desired pixel locations for measurements in a predetermined sequence. It will be appreciated that the measurement process can be conducted by other means, including manual orientation of the measurement device 104, to collect data for the desired pixel locations.

The measurement device 104 collects chromaticity data for each pixel location. In an exemplary embodiment, the measurement device 104 comprises a. spectroradiometer that collects spectral data, related to the humanly-visible electromagnetic spectrum from each pixel location. Specifically, the brightness of the display at each of a plurality of points in the visible spectrum is measured at a given pixel location, to create a spectral profile for each calibration input at each location. In the exemplary embodiment, the zero-input spectrum can be subtracted from each other spectrum to remove any background output associated with the spectroradiometer. The collected data is provided to a gain correction component 106. The gain correction component 106 calibrates the collected spectral measurements into a desired unit system. In the exemplary embodiment, each measurement is multiplied by a gain correction curve on a point-by-point basis to obtain spectral radiance measurements of each pixel location in units reflecting the power produced over a given area of display space, solid angle of the light collection cone associated with the measurement device 104, and segment of visible spectrum bandwidth.

The calibrated spectral data is then provided to an observer modeling component 108. The observer modeling component 108 adjusts the collected spectral data to obtain chromaticity values reflective of human visual response. For example, a given set of spectral data can be multiplied by one or more weighting curves that enhance the perceived brightness of some portions of the spectrum and reduce the brightness of other portions. In the illustrated implementation, the 1931 CIE Standard Observer weighting curves are applied to each spectral measurement, and appropriate tri-stimulus values (e.g., CIE X, Y, and Z) can be obtained from the weighted sums.

The tri-stimulus values are then provided to a coefficient generator 110. The coefficient generator 110 generates a plurality of precorrection coefficients for the color correction system from the provided tri-stimulus values and expected values associated with the calibration inputs. The difference between the expected color values and the measured values can be used to model the electro-optical properties of the display 120 and determine a corresponding set of precorrection coefficients. It will be appreciated that any of a variety of coefficient types can be generated at the coefficient generator 100, including coefficients related to contrast, brightness, black level, and hue properties of the display 120. In an exemplary implementation, twelve coefficients are calculated for each of the plurality of pixel locations, including six hue correction coefficients and three brightness coefficients, collectively comprising a three-by-three primary correction matrix related to the chromaticity primary values of the display, three contrast coefficients, and three offset coefficients. Three look-up tables, applicable to the entire display (e.g., not spatially dependent), can also be created from the tri-stimulus values for second-order adjustments of the balance and brightness.

The nine matrix coefficients can be determined for a given point based on the tri-stimulus values at full brightness measurement and known constraints of the chromatic primaries. For example, in an RGB system, the expected values of the tri-stimulus values for a pure color is known and the white point for the display should occur where all three primary values are equal. Appropriate matrix coefficient values can be determined from these relationships via linear algebra. Similarly, the three offset coefficients can be determined from the tri-stimulus coefficients at the zero-level input. Offsets to the display input at each pixel location can be calculated from the measured tri-stimulus values and known conversions to the display primaries to bring the black level to a desired, uniform level across the display.

The look-up table values are not spatially dependant, and can be calculated from measurements taken at a single pixel location. Accordingly, additional measurements can be taken at a selected pixel location, such as the center of the display. For example, in an RGB display, each primary can be stepped through a series of progressively brighter calibration inputs while the other two primaries are held at zero brightness. The measurements taken at each step can be used to determine the deviation of the display as a whole from a desired gamma value, γ, the gamma value representing the exponent in a power-law response of the display to the input. For a given n-bit input x, the look-up tables are designed to maintain an optical response of the display proportional to (x/2ⁿ)^{γ}.

The values of the three contrast coefficients are determined based on the mid-brightness measurement. The three contrast coefficients represent a power-law gamma correction applied to each chromaticity primary to maintain a uniform gamma response of the display at the desired gamma value, taking into account the effects of the look-up tables and the black level offsets. Thus, if the look-up table measurements are taken at a central pixel location, the contrast coefficients should ideally be equal to the desired value for the display at the central pixel locations and may deviate up or down at other locations in the display. In practice, the computed gamma values can deviate from the desired value, even at the central pixel location, due to the effect of the black level offsets.

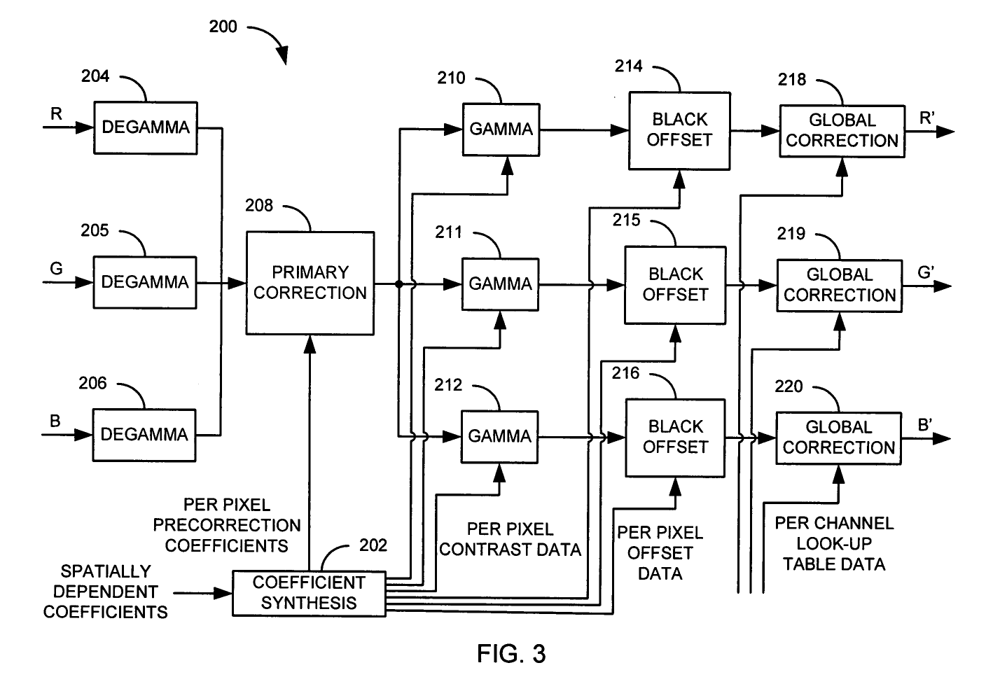

FIG. 3 illustrates an exemplary chromaticity precorrection module 200 for a color correction system in accordance with an aspect of the present invention. The chromaticity precorrection module 200 applies correction data obtained from an associated chromaticity calibration module to a set of chromaticity input values representing a pixel to be displayed at a desired pixel location via a projection system. It will be appreciated that the chromaticity precorrection module can be implemented as a computer software program on a computer readable medium, as hardware circuitry, or as a combination of the two. Accordingly, the illustrated functional components of the module can represent one or more software programs or portions thereof operating in a data processing system (e.g., a microprocessor) or appropriate dedicated circuitry for the described function. In the illustrated implementation, the three chromaticity values represent red, blue and green components of a given input pixel (e.g., an RGB color), but it will be appreciated that the input can be represented by a number of other chromaticity models, such as a YCbCr (luminance, blue chromaticity, and red chromaticity) model or a CMY (Cyan, Magenta, and Yellow) model.

A plurality of spatially dependent coefficients are received at a coefficient synthesis component 202 associated with the precorrection module 200 from an associated calibration process. The coefficients can include values for a plurality of different coefficients at each of a plurality of representative pixel locations on the display. In an exemplary embodiment, the coefficients can include one or more chromaticity correction values for each of the chromatic primaries, one or more contrast correction coefficients for each primary, and one or more offset correction coefficients for each primary. From this data, the coefficient synthesis component 202 can determine values for a given pixel location by selecting a representative pixel location that is closest to the desired location. Alternatively, coefficient values for a desired pixel location can be determined via interpolation from values associated with a subset of representative points associated with (e.g., spatially proximate to) the desired location. For example, an associated value and a set of associated partial derivative values can be stored for each coefficient at the coefficient synthesis component 202 for each of the plurality of representative points, and the coefficient synthesis component can perform an interpolation process, such as a bi-cubic spline interpolation, to obtain values for the desired pixel location according to the values of a set of nearby pixel locations. It will be appreciated as well that non-spatially dependent corrections can also be applied in the precorrection module 200.

In the illustrated example, a set of three input chromaticity values are received at respective first gamma correction components 204-206. The first gamma components 204-206 remove a fixed power-law gamma adjustment from their associated chromaticity value to convert the chromaticity values in a linear light representation (e.g., γ=1). This can be accomplished, for example, by calculating the value of each chromaticity value taken to an exponential power equal to the multiplicative inverse of the fixed gamma value. In an exemplary embodiment, the first gamma correction components 204-206 can comprise look-up tables that provide corresponding linear light representations for a given set of input chromaticity values.

The chromaticity values are then provided to a primary correction component 208. The primary correction component 208 remaps the respective primaries associated with to the chromaticity values to account for the difference between the standard RGB primaries associated with the input chromaticity values and the actual RGB primaries implemented by the projector at the evaluated pixel, as determined by the calibration process. In the illustrated example, the primary correction component applies a three-by-three matrix of nine correction coefficients to the run-time input to adjust the hue and brightness of the input. The primary correction component 208 multiplies the chromaticity values, conceptualized as a one-by-three vector, by the correction matrix to produce adjusted chromaticity values for the pixel. Each adjusted chromaticity value is a weighted linear combination of the original chromaticity values, with the weights comprising the determined matrix coefficients.

The matrix of coefficients applied at the primary correction component 208 can be designed to apply three types of adjustments to a run-time input. Six hue coefficients comprise the off-diagonal elements of the matrix and can be selected to provide a remapping of the color primaries in accordance with the calibration measurements. The overall brightness of the input can also be adjusted according to the magnitude of the coefficients, including the three diagonal coefficients. Similarly, the brightness of a particular color primary can be adjusted via the selection of coefficients for its associated row of coefficient weights. Thus, during calibration, the brightness of the image or of a particular color primary can be increased or decreased by scaling the appropriate coefficients upwards or downwards respectively.

The adjusted chromaticity values are then provided to respective second gamma correction components 210-212. The second gamma correction components 210-212 provide a power-law gamma correction to their respective chromaticity values, representing a desired contrast correction at the represented pixel. A set of gamma corrected chromaticity values can be determined by raising the each of the corrected chromaticity values output from the pixel level correction component 208 to an exponential power determined by its associated correction coefficient. Appropriate coefficients for the gamma correction can be provided by the calibration process, with each of the second gamma correction components (e.g., 210) receiving respective gamma correction coefficients. These coefficients aid in maintaining a desired, uniform level of contrast in the image, specifically at a mid-level of brightness.

The gamma corrected values are then provided to respective black offset components 214-216. The offset components 214-216 adjust the chromaticity values for any variation in the black level of the represented pixel between a measured value at the pixel during calibration and a desired, uniform black level for the display. Thus, the black level adjustments affect the balance and brightness at low brightness. The provided offset coefficients are simply added to the gamma corrected chromaticity values to adjust the pixel for any variance from the black level of the system.

Once the black level offset of the input has been adjusted, the spatially dependent corrections for the input are complete. A final, spatially-independent correction is applied at respective global correction components 218-220. In the illustrated implementation, each of the global correction components (e.g., 218) includes a look-up table containing a plurality of correction coefficients for its respective chromatic primary. The look-up table values are used to adjust the input for any non-conformance of the electro-optic transfer function of the display to desired transfer function, characterized by a power-law gamma coefficient associated with the display. The look-up table is generated from values taken at a large range of brightness values, allowing it to affect the image contrast directly across the entire tonal scale for each primary. Once the global correction has been applied to the input chromaticity values, the precorrected values can be output to an associated display.

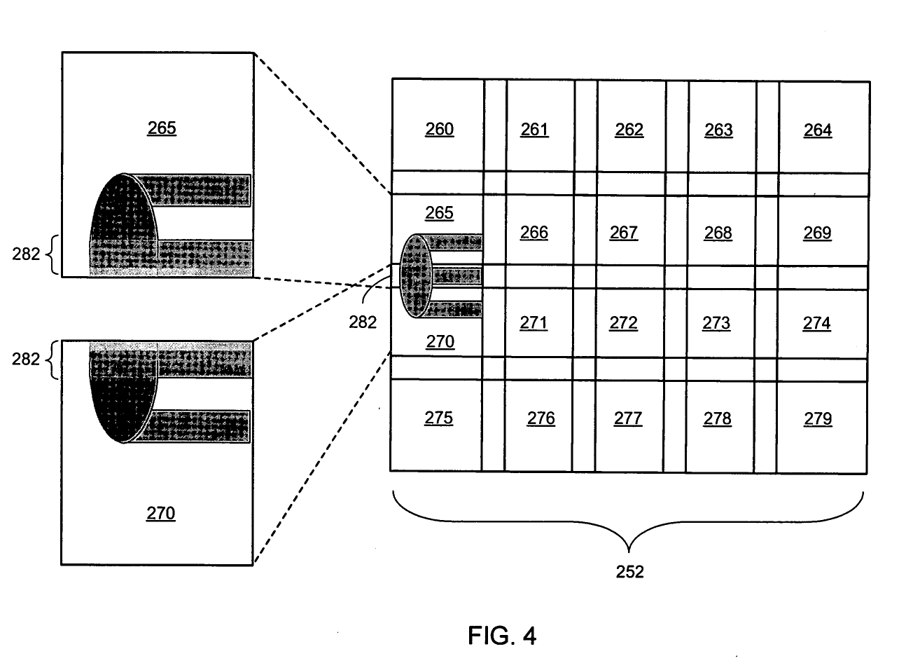

FIG. 4 illustrates an exemplary implementation of the present invention in a multi-tiled projection system 250. The exemplary system 250 comprises twenty display systems, each providing one tile of a multi-tiled display 252. Thus, the image content displayed at each of a plurality of tiles 260-279 represents one portion of a larger image. In a multi-tile system, any differences in the color properties (e.g., contrast, chromatic primaries, white point, or black offset) within or across tiles can be noticeable to an observer, often to a greater extent than they would be within a single image. Unfortunately, display systems are not ideal, and properties will vary both across different locations within a given display tile and between the various tiles. A color correction system, in accordance with an aspect of the present invention, can be employed to mitigate the variations across and within the various display tiles.

In the multi-tile display 252, the image content of the various tiles 260-279 is selected as to leave a region at the border of each tile having image content common with a neighboring tile. The tiles 260-279 are then positioned as to allow the common border region of each tile to overlap, forming an area of overlap (e.g., 282) between the tiles. This allows the image content of the tiles to be blended smoothly between tiles, mitigating the effects of any difference in chromaticity properties between the projectors, and avoiding complicated alignment issues associated with non-overlapping tiles. The border regions of each tile are cross-faded with the respective border regions of its neighboring tiles to prevent an increase in brightness at areas of overlap. The color correction system associated with each display system can facilitate the cross-fading effect by reducing the overall brightness of images at pixel locations within the border region.

For example, the bottom edge of a first tile 265 can contain matter common with the top edge of a second tile 270 located below the first tile. The tiles then positioned as to overlap, creating an overlap region 264. Within the overlap region 264, the brightness of each tile is scaled back gradually from the beginning of the overlap to the edge of the tile, such that a constant combined brightness is maintained. For example, at a midpoint of the overlap region, each tile can contribute half of the overall brightness associated with the displayed image. When the tiles are overlapped, the image in the overlap region 282 appears contiguous with the rest of the image, with no sharp changes in chromaticity at the border of the tiles 265 and 270.

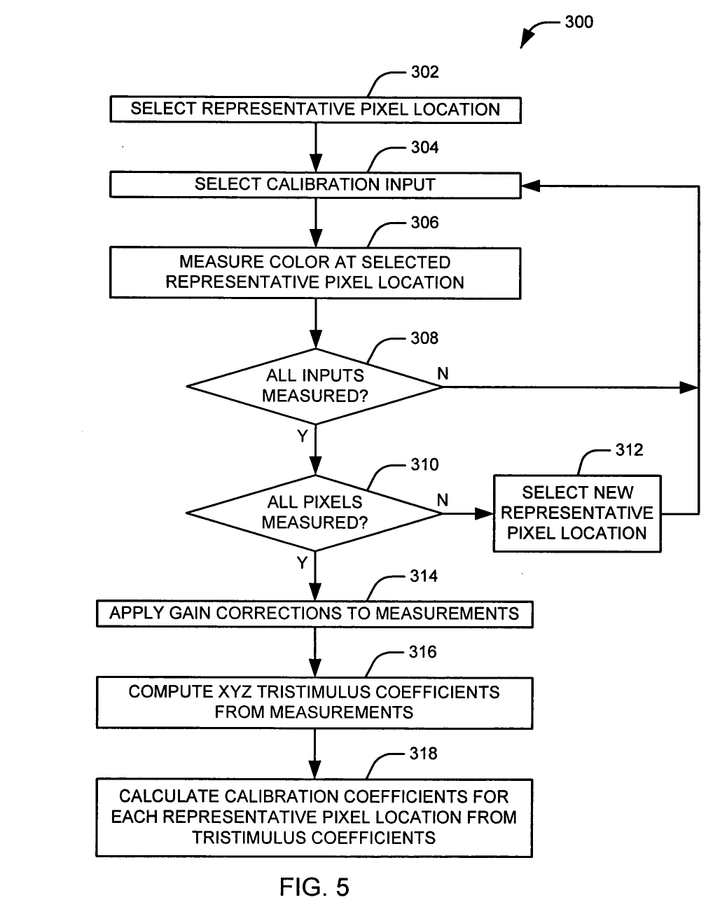

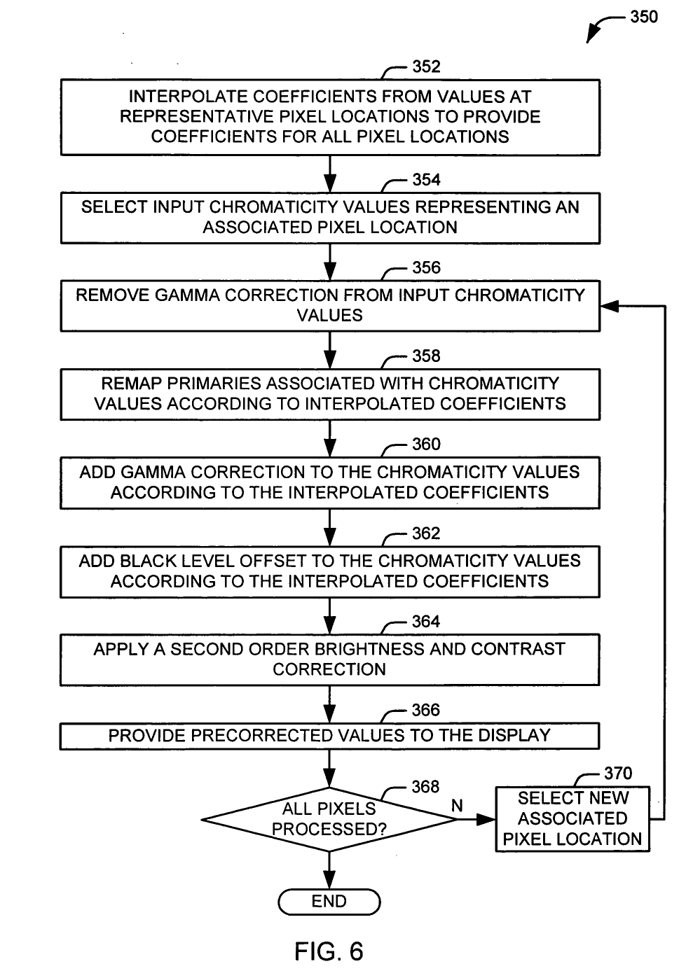

In view of the foregoing structural and functional features described above, methodologies in accordance with various aspects of the present invention will be better appreciated with reference to FIGS. 5-6. While, for purposes of simplicity of explanation, the methodologies of FIGS. 5-6 are shown and described as executing serially, it is to be understood and appreciated that the present invention is not limited by the illustrated order, as some aspects could, in accordance with the present invention, occur in different orders and/or concurrently with other aspects from that shown and described herein. Moreover, not all illustrated features may be required to implement a methodology in accordance with an aspect the present invention.

FIG. 5 illustrates an exemplary methodology 300 for calibrating a display system in accordance with an aspect of the present invention. At 302, an initial representative pixel location is selected for evaluation from a plurality of predefined representative pixel locations. At 304, a desired calibration input is selected to be provided to the display. The calibration input directs the display to provide a desired color pattern for calibration measurements. Suitable color patterns will vary with the application. In one implementation, the color patterns represent solid color patterns, such as a zero-input pattern (e.g., full black), mid-brightness patterns for each of a plurality of primary colors, and full-brightness patterns for each of the plurality of primaries.

At 306, one or more chromaticity characteristics of the displayed color pattern are measured at the selected representative pixel location. For example, the brightness of the light reflected or emitted from the display can be measured for each of a plurality of wavelengths within the visible light spectrum. At 308, it is determined if all of a plurality of desired calibration inputs have been evaluated. If not (N), the methodology returns to 304 to select a new calibration input for evaluation. If so (Y), the methodology advances to 310, where it is determined if all of a plurality of desired representative pixel locations have been measured for the display. If not, the methodology proceeds to 312, where a new representative pixel location is selected. This can be accomplished, for example, by directing an automated system, such as an x-y “gantry” type positioning system, to reposition a measuring device to target a new pixel location. The methodology then returns to 304 to evaluate the newly selected pixel location. If all of the pixel locations have been evaluated, the methodology proceeds to 314.

At 314, respective gain corrections are applied to the acquired measurements to calibrate the measurements to a desired scale and unit reference. The gain correction adjusts the measured values for differences in perceived power across visual spectrum wavelengths. This can be accomplished, for example, via a point-by-point multiplication of the measured power at each wavelength by a plurality of values comprising a gain correction function. At 316, the measurements are converted into luminance, red chromaticity, and blue chromaticity tri-stimulus values, reflective of the brightness of each point to a human observer. For example, the values calculated at each wavelength for a given location can be multiplied by corresponding values of each of the 1931 CIE Standard Observer weighing curves, and a corresponding weighted sum can be calculated to provide each tri-stimulus value for the location.

Once appropriate tri-stimulus values have been calculated, appropriate coefficient values are calculated to produce a model of the behavior of the display system at 318. The coefficient values can be calculated from the tri-stimulus values by any appropriate means, and the method of calculation can depend on the choice of primaries for the display device. For example, if the display device utilizes a CIE XYZ color space, the calculation of desired coefficients from the tri-stimulus values and the expected chromaticity values is trivial. If a different color space is used, an appropriate calculation, such as a matrix transformation, can be performed to obtain coefficients appropriate to the primaries of the new color space. Once the coefficient values have been calculated for each representative pixel locaiton, they can be utilized to generate further precorrection coefficients for run-time input chromaticity values associated with other pixel locations.

FIG. 6 illustrates an exemplary methodology 350 for precorrecting a run-time input to a display system in accordance with an aspect of the present invention. At 352, appropriate calibration coefficients for all pixel locations within the input are calculated via interpolation from respective sets of reference values for each coefficient representing a plurality of representative pixel locations. For example, the reference values can represent a grid of pixel locations, as discussed above, and values for point intermediate to those on the grid can be interpolated. The reference values can be provided via an associated calibration process for the display. The interpolation can be accomplished by any appropriate two-dimensional interpolation algorithm, such as a two-dimensional linear interpolation or a bi-cubic spline interpolation. Other applicable interpolation techniques will be apparent to one skilled in the art. At 354, a set of input chromaticity values, representing an associated pixel location, are selected at the display system. The chromaticity values can represent brightness or intensity values for each of three chromaticity primaries associated with the display system.

A fixed power-law gamma correction can be removed from each of the selected chromaticity values at 356 to reduce the values to a linear light representation. This can be accomplished via direct calculation of an exponential power equal to the multiplicative inverse of the fixed gamma value for each chromaticity value. Alternatively, appropriate linear light values can be provided in the form of a look-up table. The methodology then advances to 358, where the chromaticity values are adjusted as to remap their associated chromatic primaries according to the modeled behavior of the display, as represented by the interpolated calibration coefficients. For example, the values can be adjusted to account for differences between an expected appearance for a given value of a chromatic primary and the actual hue or the brightness displayed for the value. In an exemplary embodiment, corrected chromaticity values are calculated as weighted linear sums of the original chromaticity values, with the weights for each sum comprising one or more of the calibration coefficients obtained through interpolation.

At 360, a gamma correction specific to the pixel location of the input is provided to each of the chromaticity values. A set of appropriate gamma coefficients for the three chromaticity values can be provided from the calibration coefficients determined for the input pixel location via interpolation. The gamma correction coefficient affects the contrast of the display, specifically around mid-levels of brightness. A gamma corrected value for a given chromaticity value can be determined by calculating an exponential power, equal to the provided gamma coefficient, for the chromaticity value. The methodology then advances to 362, where a black level offset is provided to each chromaticity value according to its associated pixel location to maintain a uniform black level across the image. An appropriate correction for each chromaticity value can be provided from the interpolated calibration coefficients. The provided offset values are added to their respective chromaticity values to adjust them for the determined black level characteristics of the display.

At 364, second order brightness and contrast corrections are applied to the chromaticity values to adjust the brightness and contrast associated with each chromaticity value at a plurality of different brightness levels. In an exemplary implementation, the second order correction for a given chromaticity value is determined by setting the value of the other two chromaticity primaries to zero and taking measurements as the intensity value of the primary of interest is stepped through a series of closely-spaced values spanning the range of intensity for the primary. A look-up table for the primary is then calculated from these values, with the look-up table values selected to maintain an optimal power-law response (e.g., maintain a constant desired gamma value for the display) to the chromaticity inputs. Unlike the other corrections, the second order corrections for each chromaticity primary can be calculated at a single pixel location for the image as a whole, unlike the spatially dependent corrections described above. It will be appreciated, however, that the second level corrections can be calculated in a spatially dependent manner, with the array of look-up table values being calculated for each of the plurality of reference pixel locations and values for a desired pixel location being determined via interpolation.

At 366, the precorrected input chromaticity values are provided to the display. It is then determined at 368 if all of the pixels in the input have been processed. If not all of the pixels have been processed (N), the methodology advances to 370, where a set of chromaticity values associated with a new pixel location are selected. The methodology then returns to step 356 to process the newly selected values. If all of the pixels in the input have been processed (Y), the methodology terminates.

What has been described above includes exemplary implementations of the present invention. It is, of course, not possible to describe every conceivable combination of components or methodologies for purposes of describing the present invention, but one of ordinary skill in the art will recognize that many further combinations and permutations of the present invention are possible. Accordingly, the present invention is intended to embrace all such alterations, modifications, and variations that fall within the spirit and scope of the appended claims.

What is claimed is:

1. A color display correction system comprising:
a calibration module that determines values for at least one spatially dependent precorrection coefficient at each of a plurality of representative pixel locations on an associated display; and
a precorrection module that precorrects a plurality of input chromaticity values associated with a pixel location according to the pixel location and the determined values of the at least one spatially dependent precorrection coefficient to produce precorrected chromaticity values.

2. The system of claim 1, the precorrection module comprising at least one offset component that applies a black level offset correction to the input chromaticity values according to a spatially dependent offset correction coefficient determined at the calibration module and the associated pixel location of the input chromaticity values.

3. The system of claim 1, the precorrection module comprising at least one gamma correction component that applies a power-law gamma correction to the input chromaticity values according to a spatially dependent gamma correction coefficient determined at the calibration module and the associated pixel location of the input chromaticity values.

4. The system of claim 1, further comprising a spectroradiometer that measures the color content of the display at a plurality of representative pixel locations.

5. The system of claim 4, further comprising an automated system that aligns the spectroradiometer with each of the plurality of representative pixel locations.

6. The system of claim 4, the calibration module including a coefficient generator that calculates at least one spatially dependent precorrection coefficient for each of the plurality of representative pixel locations according to a desired color content and the measured color content at the representative pixel location.

7. The system of claim 6, the precorrection module comprising an coefficient synthesis component that computes at least one coefficient value for a new pixel location according to the respective calculated values of the at least one coefficient for an associated subset of the plurality of representative pixel locations.

8. The system of claim 7, the at least one coefficient value for the new pixel location comprising a plurality of coefficient values, and a given precorrected chromaticity value comprising a weighted linear combination of the plurality of input chromaticity values, each input chromaticity value being weighted by a corresponding one of the plurality of coefficient values.

9. The system of claim 1, the display comprising a projector that projects an image onto a projection screen.

10. The system of claim 1, the display comprising a first tile of a larger display comprising a plurality of tiles, the calibration system selecting the at least one spatially dependent precorrection coefficient as to maintain uniform chromaticity properties across the plurality of tiles.

11. The system of claim 10, wherein adjacent tiles from the plurality of tiles include an area of overlap, and the precorrection module includes a global correction component that decreases the overall luminance of the display at the border of the first tile as to facilitate a cross-fade in an area of overlap between the first tile and an adjacent tile.

12. A method for calibrating a display system, comprising:
providing a calibration input to a display to instruct the display system to display a desired color at a plurality of pixel locations;
measuring an actual color displayed at the plurality of pixel locations; and
computing a set of calibration coefficients associated with each of the plurality of pixel locations according to the desired color and the actual color at each pixel location.

13. The method of claim 12, wherein a plurality of calibration inputs are provided to the display, with a given calibration input being associated with one of a plurality of desired colors, an actual color being measured at the plurality of pixel locations corresponding to each desired color, and the calibration coefficients being computed according to the respective differences of the plurality of desired colors and their corresponding actual colors.

14. The method of claim 12, further comprising calculating a given calibration coefficient for a new pixel location according to the computed values for the calibration coefficient of an associated subset of the plurality of pixel locations.

15. The method of claim 14, wherein calculating the calibration coefficients for the new pixel location includes interpolating the computed coefficient values of the associated subset of pixel locations for the coefficient according to a position of the new pixel location relative to respective positions of the subset of pixel locations.

16. The method of claim 11, wherein computing the set of calibration coefficients for a given pixel location includes determining the difference in appearance of the desired color and the measured actual color to a standard human observer according to colorimetric models.

17. The method of claim 11, further comprising computing at least one gamma correction coefficient for each pixel location the desired color and the actual color at each pixel location.

18. The method of claim 11, further comprising precorrecting at least one run-time set of chromaticity coefficients, having an associated pixel location, to the display system according to the set of computed calibration coefficients associated with the associated pixel location.

19. A display system comprising:
means for displaying a desired color at a plurality of pixel locations according to a calibration input;
means for measuring the actual color at the plurality of pixel locations;
means for calculating at least one precorrection coefficient for each of the plurality of pixel locations from the desired color and the measured actual color; and
means for precorrecting at least one input chromaticity value associated with a pixel location according to the calculated precorrection coefficients and the associated pixel location of the at least one input chromaticity value.

20. The system of claim 19, the means for precorrecting comprising means for computing a given precorrection coefficient for a new pixel location according to the calculated values for the coefficient for an associated subset of the plurality of pixel locations.

21. The system of claim 19, the means for precorrecting at least one input chromaticity value including means for removing an associated gamma correction from a given one of the at least one chromaticity value.

22. The system of claim 21, the means for precorrecting including means for providing a spatially dependent gamma correction to the given chromaticity value according to the associated location of the at least one input chromaticity value.

23. A system for correcting a set of input chromaticity values, associated with one of a plurality of pixel locations on a display comprising:
a coefficient synthesis component that determines a set of at least one correction coefficient for the input chromaticity values according to the associated location of the set of input chromaticity values and reference coefficient values for a plurality of reference pixel locations associated with the display; and
at least one correction component that provides chromaticity correction to the chromatic input according to the determined at least one correction component.

24. The system of claim 23, the at least one correction component comprising at least one offset component that applies a black level offset correction to the set of input chromaticity values according to the determined set of at least one correction coefficient.

25. The system of claim 23, the at least one correction component comprising at least one gamma correction component that applies a gamma correction to the set of input chromaticity values according to the determined set of at least one correction coefficient.

26. The system of claim 23, the at least one correction component comprising a primary correction component that computes a set of precorrected chromaticity values, a given precorrected chromaticity value comprising a weighted linear combination of the set of input chromaticity values, each input chromaticity value being weighted by a corresponding one of the determined set of at least one correction coefficient.

27. The system of claim 23, the coefficient synthesis component determining a given correction coefficient for a new pixel location by interpolating among an associated subset of the reference values for the coefficient.
